(19) United States
(12) Patent Application Publication
(10) Pub. No.: US 2012/0105239 A1
(43) Pub. Date: May 3, 2012

(54) FAULT SIGNALING DEVICE, PARTICULARLY FOR ELECTRICAL APPARATUSES SUCH AS INTERLOCKED SOCKETS

(76) Inventor: Bruno Levi, Brescia (BS) (IT)

(21) Appl. No.: 13/138,562

(22) PCT Filed: Apr. 15, 2010
(86) PCT No.: PCT/EP10/02311

§ 371 Date: Sep. 1, 2011

(30) Foreign Application Priority Data
Apr. 17, 2009 (IT) MI2009A000635

(51) Int. Cl. G08B 21/00

(52) U.S. Cl. 340/638

(57) ABSTRACT

A fault signaling device, particularly for electrical apparatuses such as interlocked sockets and the like has an indicator constituted by a lamp (12) which is directly connected to the terminals of a fuse (5) whose blowing causes the lamp to lighted up. The lamp is mounted in the same supporting member (3) that contains the fuse.

The present invention relates to a fault signaling device and in particular to an indicator that signals the burning of a fuse in an interlocked socket.

As is known, interlocked sockets incorporate mechanical or electrical locking devices which are connected to interruption devices, generally constituted by rotary switching apparatuses, in order to ensure that a plug cannot be inserted or extracted in the presence of power.

Interlocked sockets are also provided with protective fuses in order to ensure the safety of the operators and the integrity of the apparatuses with high absorptions.

In case of anomalies, for example of overcurrents, the protection fuse blows, interrupting the power supply.

The interlocked socket can be provided with indicators that light up to indicate that the fuses have blown in order to facilitate identification of the fault on the part of operators.

The indicators are normally inserted in adapted receptacles within the body of the socket and are connected to the respective fuses by means of adapted wiring, which when a fuse blows, causes the corresponding control indicator to light up.

Because of an anomaly of the circuit of the control indicator, the indicator may fail to turn on if the fuse associated with it blows.

The aim of the present invention is to provide a signaling device that is more reliable than conventional devices.

An object of the invention is to provide a signaling device with a structure which is compact and simplified and allows to reduce the production cost of the electrical apparatus in which it is installed.

A further object of the invention is to provide a signaling device which is versatile and can be applied to apparatuses of a different type.

A further object of the present invention is to provide a device which, by virtue of its particular constructive characteristics, is capable of giving the greatest assurances of reliability and safety in use.

This aim and these and other objects that will become better apparent hereinafter are achieved by a fault signaling device, particularly for electrical apparatuses such as interlocked sockets and the like, characterized in that it comprises an indicator constituted by a lamp which is directly connected to the terminals of a fuse whose blowing causes said lamp to light up.

The lamp is mounted within the same supporting member that contains the fuse.

Further characteristics and advantages will become better apparent from the description of preferred but not exclusive embodiments of the invention, illustrated by way of non-limiting example in the accompanying drawings, wherein:

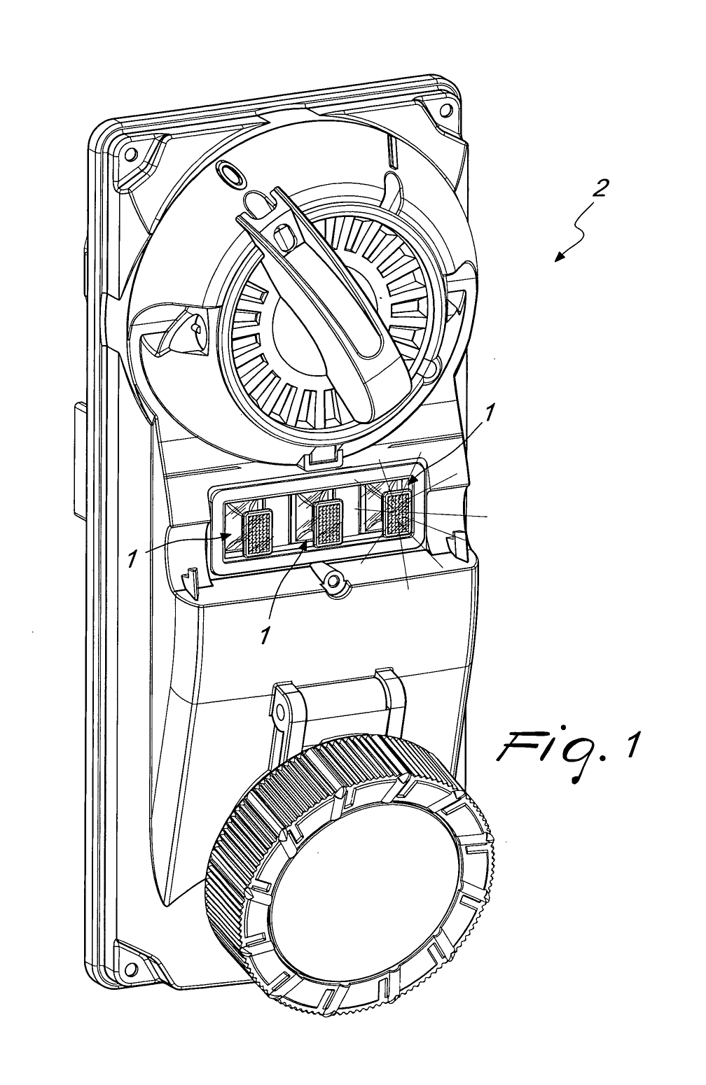

FIG. 1 is a perspective view of an interlocked socket provided with the fault signaling device according to the present invention;

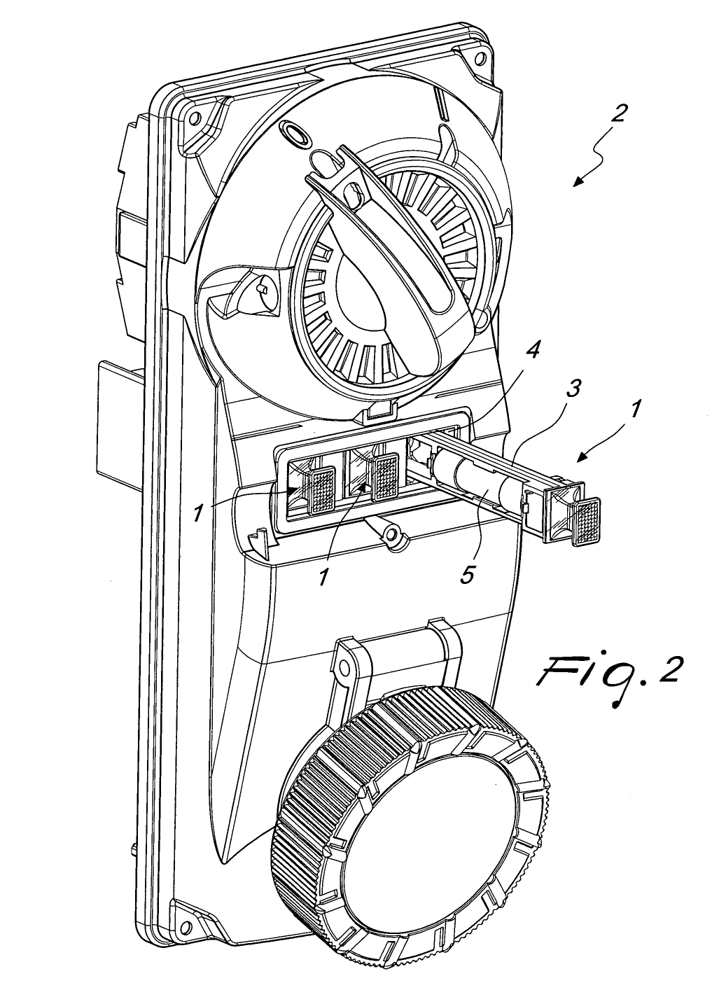

FIG. 2 is a perspective view of the interlocked socket illustrating the fuse holder tray in the open position;

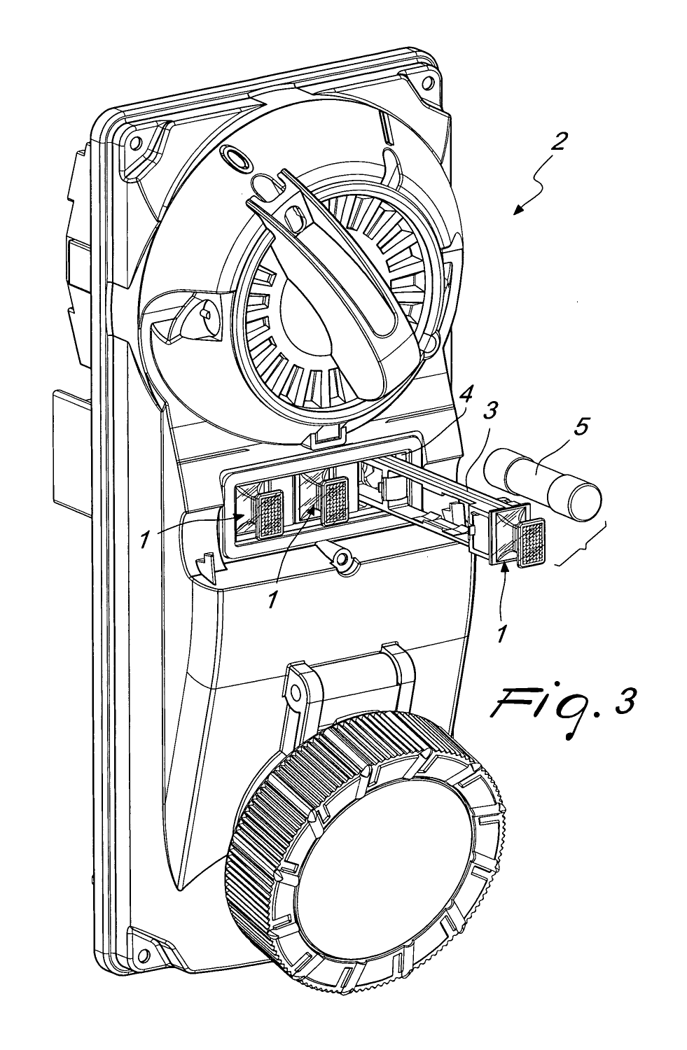

FIG. 3 is a perspective view of the interlocked socket which shows the fuse holder tray in the open position with the fuse extracted;

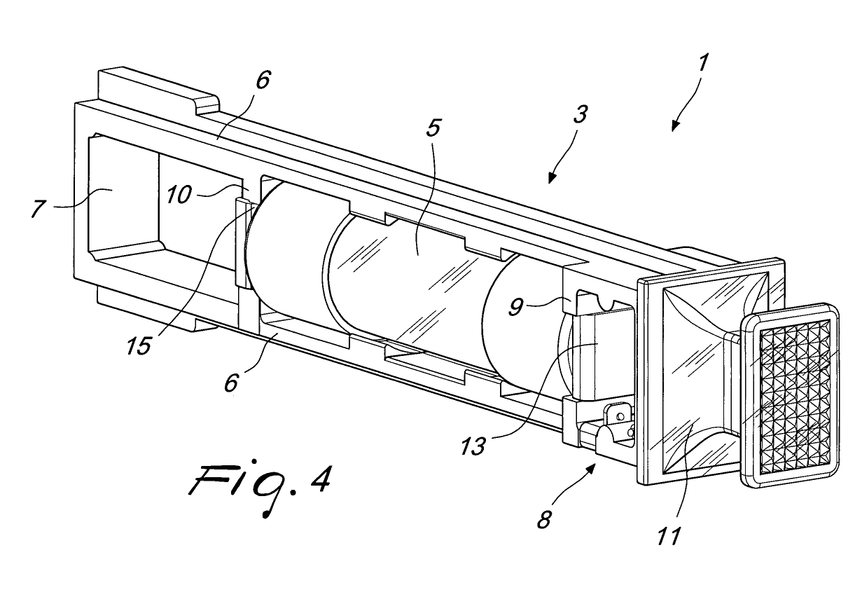

FIG. 4 is a perspective view of the device that includes the fuse holder tray with the fuse inserted;

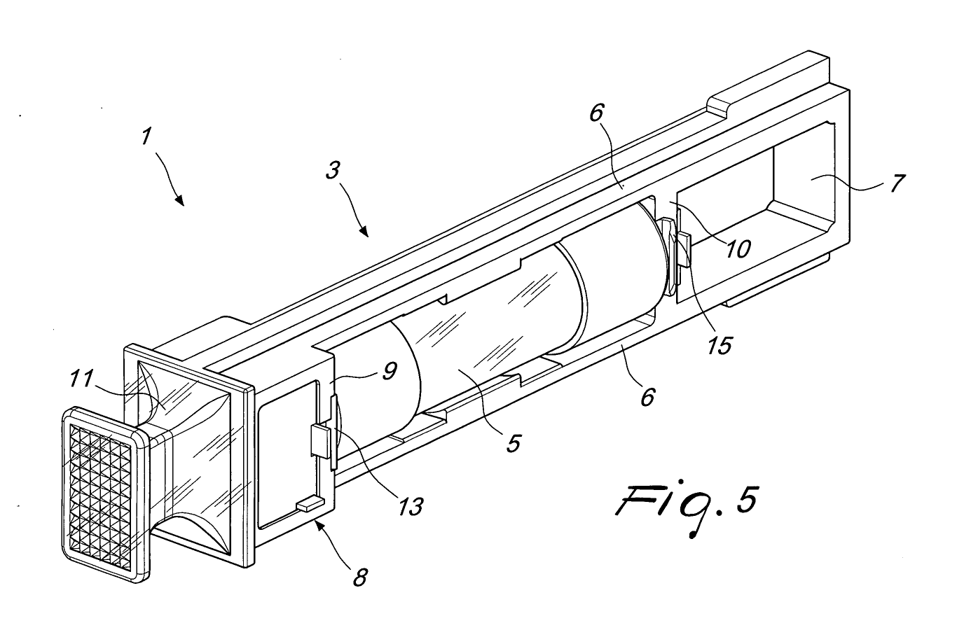

FIG. 5 is another perspective view of the fuse holder tray with the fuse inserted;

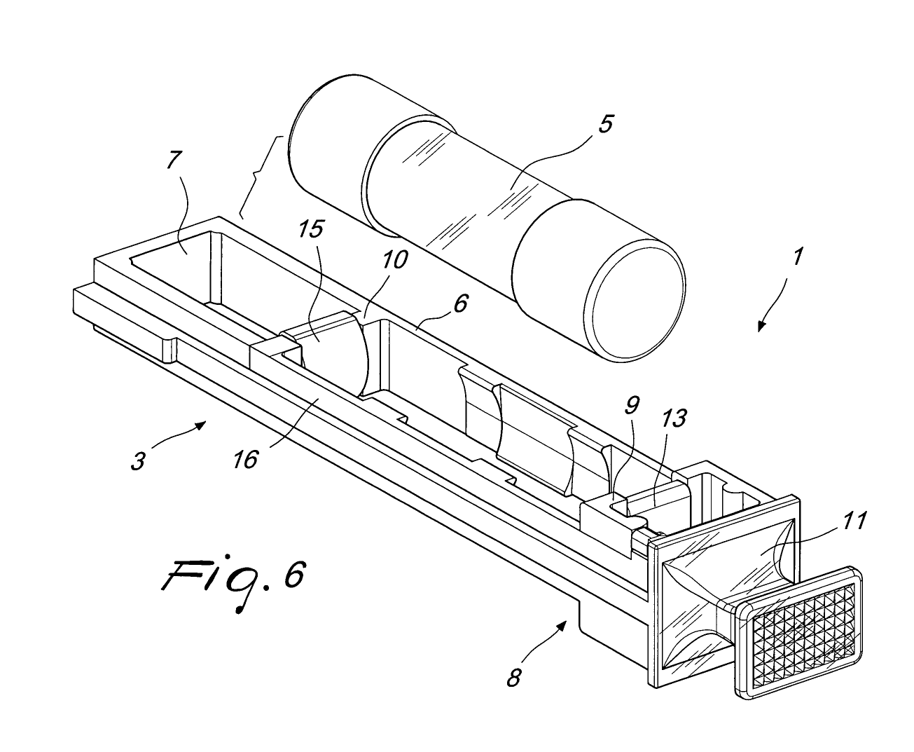

FIG. 6 is a perspective view of the fuse holder tray with the fuse extracted;

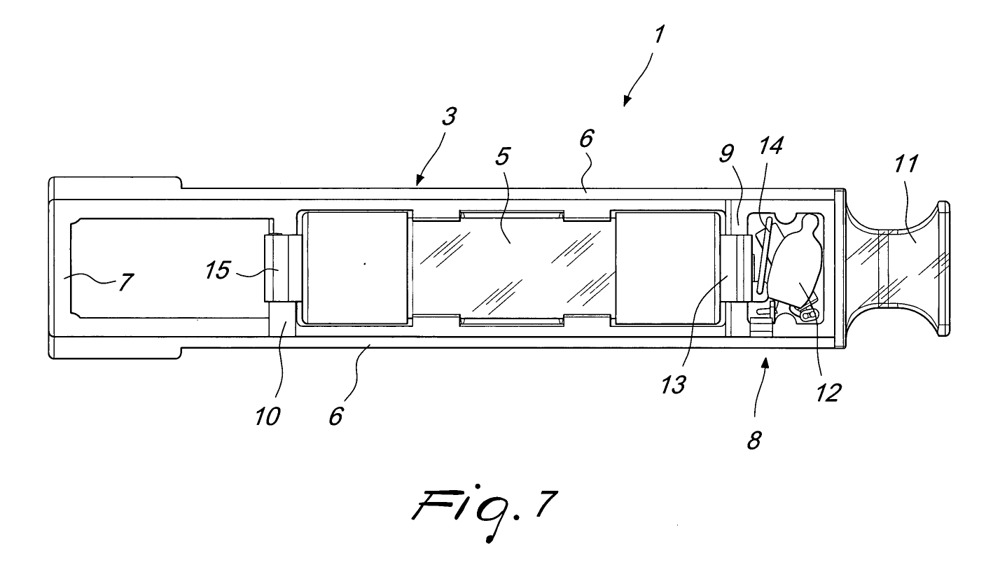

FIG. 7 is a side view of the fuse holder tray of the device according to the present invention;

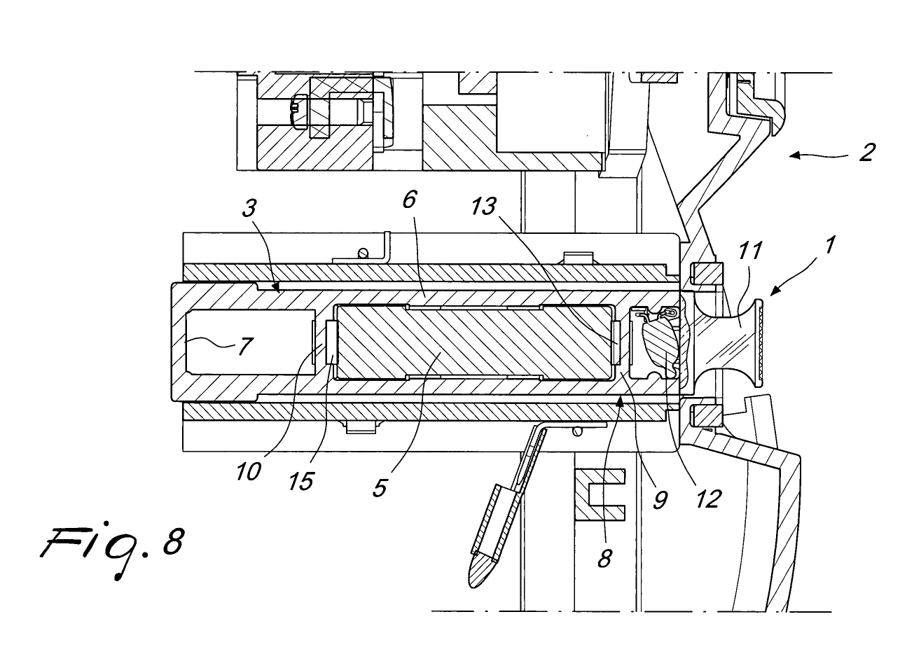

FIG. 8 is a sectional side view of the portion of the interlocked socket that contains the device according to the present invention;

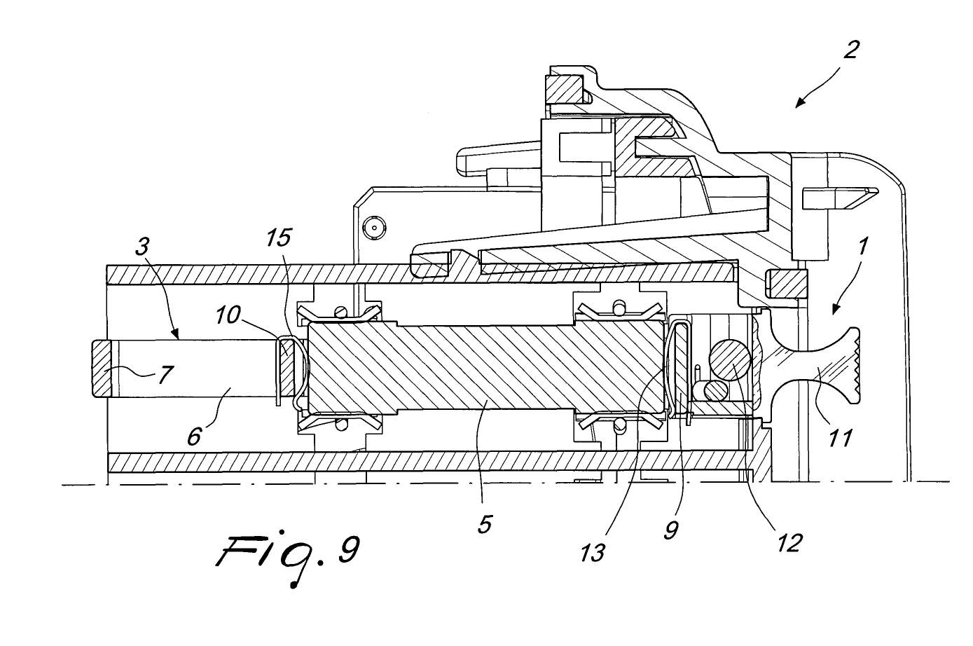

FIG. 9 is a sectional plan view of the portion of the interlocked socket that contains the device according to the present invention;

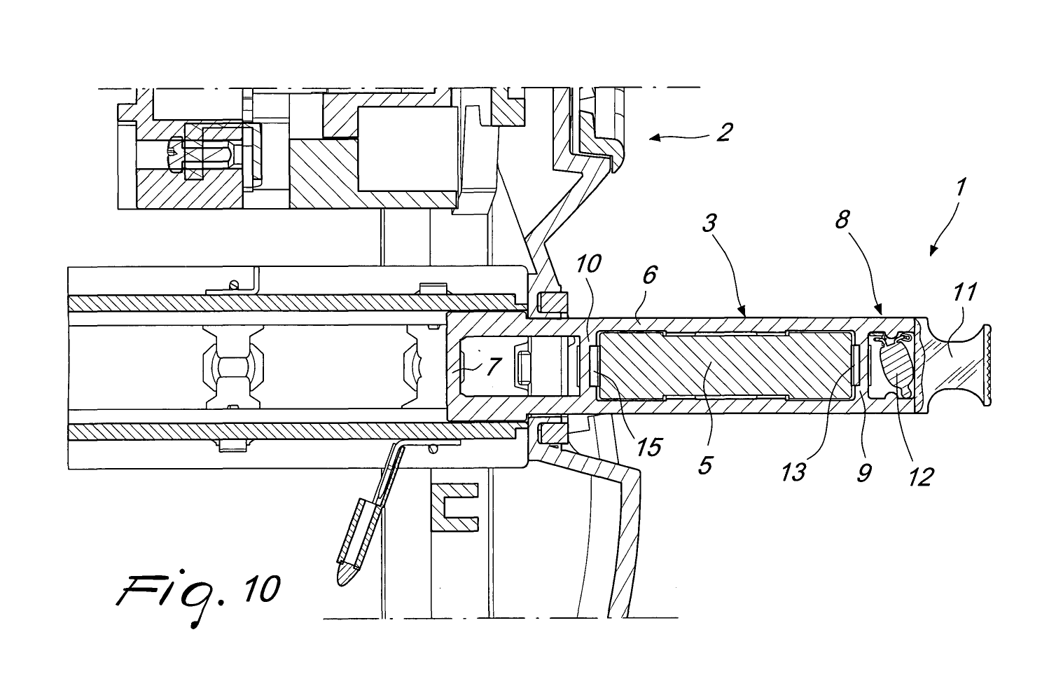

FIG. 10 is a sectional side view, similar to FIG. 8, which illustrates the portion of the interlocked socket that contains the device according to the present invention, wherein the fuse holder tray is shown in the position in which it is extracted from its seat.

With reference to the cited figures, the device according to the invention, generally designated by the reference numeral 1, is shown applied to an interlocked socket, generally designated by the reference numeral 2.

In the specific case, the interlocked socket has three signaling devices for a corresponding number of fuses, each of which is associated with a respective fuse holder.

The fuse holder includes a tray 3 which is inserted in a seat 4 and is adapted to accommodate a fuse 5.

The tray 3 is constituted by a frame that comprises a pair of longitudinal members 6 joined by a bottom 7, a front portion 8 and an intermediate upright 10.

The front portion 8 has a chamber which is open laterally and comprises an internal partition 9 and a grip member 11 that protrudes externally.

At least the grip member 11 is made of a transparent material, so as to allow the viewing of an indicator 12 which is arranged in the chamber formed by the front portion 8.

The indicator 12 is preferably constituted by a neon bulb which is connected electrically to a front terminal 13 by means of a spring 14.

The front terminal 13 is constituted by an elastic plate which is associated with the internal partition 9 and is in direct contact with one end of the fuse 5.

The other end of the fuse 5 is also in contact with an elastic blade 15, which is associated with the intermediate upright 10 and forms a rear terminal.

The elastic blade 15 is connected electrically, by means of a conductor 16 that runs along one of the longitudinal members 6, to the second terminal of the neon bulb.

In this manner, the neon bulb 12 has a direct contact on the two terminals of the fuse 5.

The blowing of the fuse 5 causes the lighting of the neon bulb 12, which is visible through the grip member 11, which is transparent, allowing to immediately identify the tray to be extracted in order to replace the fuse.

In practice it has been found that the invention achieves the intended aim and objects, providing a signaling device constituted by an indicator that is integrated within the support of the fuse.

An advantage of the present invention is constituted by the direct connection of the lamp 12 to the terminals of the fuse, which leads to higher reliability in operation of the indicator.

Another advantage is constituted by the constructive simplicity of the structure of the device, which leads to low production costs.

This application claims the priority of Italian Patent Application No. MI2009A000635, filed on Apr. 17, 2009, the subject matter of which is incorporated herein by reference.

1. (canceled)

2. (canceled)

3. (canceled)

4. (canceled)

5. (canceled)

6. (canceled)

7. A fault signaling device, particularly for electrical apparatuses such as interlocked sockets and the like, comprising an indicator constituted by a lamp which is directly connected to the terminals of a fuse whose blowing causes said lamp to light up, said lamp being mounted in the same supporting member that contains said fuse, further comprising a fuse holder which comprises a tray which is inserted in a seat of said electrical apparatus and accommodates said fuse, said tray being constituted by a frame comprising a pair of longitudinal members joined by a bottom, a front portion and an intermediate upright, said front portion comprising a chamber which is open laterally and comprises an internal partition and a grip member which lies externally with respect to the surface of said electrical apparatus in which said tray is inserted, at least said grip member being made of transparent material, so as to make said indicator visible, said indicator being arranged in said chamber formed by said front portion.

8. The fault signaling device according to claim 7, wherein said indicator is constituted by a neon bulb which is electrically connected to a front terminal by means of a spring, said front terminal being constituted by an elastic plate which is associated with said internal partition and is in direct contact with one end of said fuse, the other end of said fuse being disposed in contact with an elastic blade, which is associated with said intermediate upright and forms a rear terminal, said front and rear terminals being electrically connected to the two terminals of said neon bulb.
